(19) United States
(12) Patent Application Publication
(10) Pub. No.: US 2023/0052932 A1
(43) Pub. Date: Feb. 16, 2023

(54) APPARATUS AND METHOD FOR SHAPING A STRAND-SHAPED FOODSTUFF

(71) Applicant: TPV GMBH, Oberlahr (DE)

(72) Inventor: Uwe Reifenhäuser, Flammersfeld (DE)

(73) Assignee: TPV GMBH, Oberlahr (DE)

(21) Appl. No.: 17/797,300

(22) PCT Filed: Feb. 8, 2021
(86) PCT No.: PCT/EP2021/052946

§ 371 Date: Aug. 3, 2022

(30) Foreign Application Priority Data
Feb. 10, 2020 (DE) 10 2020 103 304.4

(51) Int. Cl. A22C 7/00; A23L 13/00

(52) U.S. Cl. CPC A22C 7/0023; A23L 13/03; A23V 2002/00

(57) ABSTRACT

An apparatus for shaping a strand-shaped foodstuff, in particular a piece of meat, is disclosed. The apparatus includes a pressing chamber which is delimited by walls, at least one of which is movable by means of a pressing device and is designed as a ram, whereby the pressing chamber can be transitioned from an initial state with a first enclosed volume into a final state with a second enclosed volume. The apparatus also includes a feed device for feeding the foodstuff into the pressing chamber, and a discharge device for discharging the foodstuff from the pressing chamber. In order to provide an apparatus which is suitable for simple integration into a conveyor system, the feed device and/or the discharge device is a transport belt which at least partially covers one of the walls in an interior of the pressing chamber. In addition, a method for shaping a strand-shaped foodstuff is also disclosed.

### PREAMBLE

The invention relates firstly to an apparatus for shaping a strand-shaped foodstuff, in particular a piece of meat, having
a) a pressing chamber which is delimited by walls, at least one of which is movable by means of a pressing device and is designed as a ram, whereby the pressing chamber can be transitioned from an initial state with a first enclosed volume into a final state with a second enclosed volume,
b) a feed device for feeding the foodstuff into the pressing chamber,
c) a discharge device for discharging the foodstuff from the pressing chamber.

Moreover, the invention relates to a method for shaping a strand-shaped foodstuff, in particular a piece of meat.

### PRIOR ART

For industrial portioning and packaging of strand-shaped foodstuffs, in particular pieces of meat, the foodstuffs are generally divided into slices by means of a cutting machine and are subsequently transferred to a packaging device, which packs a specific number of separated slices together in one package. The number of slices contained in a package hereby conforms to a quantity indicated on the package, wherein a quantity of the foodstuff actually contained in the package may deviate from the indicated quantity only within a legally prescribed range.

Given strand-shaped foodstuffs, especially given pieces of meat, the typically non-uniformly shaped surface has been found to be problematic as it especially hinders a cutting off of slices of the same weight at constant slice thickness. However, an adaptation of the slice thickness is only accepted within relatively narrow limits, so that the quantity actually contained in the package frequently exceeds the indicated weight in order to maintain compliance with the statutory requirements.

In order enable a cutting off of slices of the same weight, or of precisely weighted portions of such slices, even given non-uniformly shaped foodstuffs, apparatuses for shaping foodstuffs are therefore known by means of which the foodstuff can be pressed into a predetermined shape, for example into the shape of a cuboid or at least of a cuboid-like volume. It can hereby be ensured that the separated slices substantially coincide in a cross-sectional area, whereby a cutting off of the shaped foodstuff with approximately consistent slice thickness is enabled.

An apparatus described above is disclosed in EP 1 595 456 A2. The apparatus comprises a pressing chamber comprising six walls, three of which are designed as movable rams. A wall forming a base plate of the pressing chamber is firmly anchored. A rear side of the pressing chamber is likewise designed as an immovable wall. The foodstuffs to be shaped are fed to the pressing chamber by means of a conveyor belt, wherein the foodstuffs are conveyed by means of the conveyor belt from a first plane to an edge region of the conveyor belt and subsequently fall onto the base plate, which is arranged vertically below the conveyor belt. It is thereby provided that two foodstuffs separated from one another by means of a separating part are shaped simultaneously by means of the apparatus, in that the walls designed as rams are moved. After the shaping process, a wall forming a side is moved in such a way that an opening cross-section of the pressing chamber is released. The two shaped foodstuffs are then conveyed out of the pressing chamber by means of a movement of the opposite ram.

DE 10 2016 122 126 A1 likewise discloses an apparatus for shaping a foodstuff. The apparatus comprises a pressing chamber with two walls which are designed as rams, by means of which the foodstuff can be shaped. The foodstuff is hereby fed to the pressing chamber by means of a transport belt which is oriented at an angle to a horizontal and has a first movement direction. The shaping process takes place following this. In order to remove the foodstuff from the pressing chamber, a wall forming a side is moved in order to uncover an opening cross-section, while a ram arranged on an opposite side is moved in order to convey the foodstuff out of the pressing chamber and to transfer it to the transport belt, which runs in a an opposite movement direction — as compared to the first movement direction — and is likewise oriented at an angle relative to the horizontal. A feed opening of the pressing chamber thus corresponds to a discharge opening of the pressing chamber.

DE 20 2005 018 374 U1 describes an apparatus for shaping a foodstuff, which apparatus has a pressing chamber and a transport belt for feeding the foodstuff into and out of the pressing chamber. For this purpose, the apparatus has a means for receiving the foodstuff, which means is coupled to the transport belt so that the means is also moved during a movement of the transport belt. By means of the transport belt, the foodstuff lying on the means is conveyed to a pressing chamber which shapes the foodstuff by means of its rams. After the shaping process, the means conveys the foodstuff out of the pressing chamber.

Furthermore, from DE 2 140 585 A an apparatus is known for pressing meat products, in particular pork bellies, with a plurality of rollers which are oriented parallel to one another and form between themselves a press nip through which the meat product to be pressed is guided. A transport belt on which the meat product rests is thereby used as the conveying device. Given the previously known apparatus, opposite roller pairs are arranged so that a press nip formed between them is increasingly reduced in the feed direction. A pressing chamber within the meaning of an apparatus of the type forming the basis of this application, in which the foodstuff is stationary during the pressing process, is not present. The previously known apparatus also does not function when the transport belt is stationary, since otherwise no further movement of the meat product through the roller pairs would be enabled, but such a further movement is indispensable to achieving the pressing effect. Namely, given a stationary transport belt, a relative sliding movement between the surface of the transport belt and the upper pressing rollers would need to occur, which cannot be performed.

### OBJECT

It is an object of the present invention to develop an apparatus for shaping a foodstuff, which apparatus is suitable for simple integration into a conveyor system. This object is to be fulfilled analogously for a method for shaping a foodstuff.

### ACHIEVEMENT

Starting from the aforementioned apparatus, the above object is achieved in that the feed device and/or the discharge device is a transport belt which at least partially covers one of the walls in an interior of the pressing chamber.

Within the meaning of this application, an “enclosed volume” is understood to mean a volume that is enclosed by an arbitrarily shaped surface, wherein at least parts of the enclosing surface do not necessarily need to be physically present. Rather, the surface can be formed partially by planes which are formed by an imaginary extension of existing components, wherein intersections of such planes with other imaginary planes on the one hand, or the physical components on the other hand, define the volume.

Within the meaning of this application, the “initial state” of the pressing chamber is understood to mean a state of the pressing chamber in which the pressing chamber is dimensioned at least in such a way that a foodstuff to be shaped can be placed into the pressing chamber without a deformation of the foodstuff already occurring. It is thereby preferably provided that the walls of the pressing chamber in the initial state are arranged at a distance from a surface of the foodstuff. However, it is also likewise conceivable that the walls are at least partially in contact with the surface of the foodstuff. In particular, in its initial state, the pressing chamber is not necessarily in that state in which it encloses the largest volume. The initial state can consequently be dependent on a volume of the foodstuff to be shaped.

Within the meaning of this application, the “final state” of the pressing chamber is understood to mean that state of the pressing chamber in which the latter is in contact with the foodstuff to be shaped, in particular transmits pressing forces to the said foodstuff, whereby it has been transitioned into its shaped state.

A shaping process in which the foodstuff is transitioned from an unshaped state into a shaped state consequently takes place in the course of a conversion of the pressing chamber from its initial state into its final state.

The apparatus according to the invention has many advantages. A particular advantage of the apparatus is that the foodstuff to be shaped can be fed to and discharged from the pressing chamber automatically, i.e., without manual assistance. Labor costs, as well as a time expenditure for transferring the shaped foodstuff out of the apparatus, can hereby advantageously be minimized so that a throughput of the apparatus is improved. It is hereby preferably provided that the wall covered by the transport belt forms a floor of a pressing chamber. In comparison to the known devices, a receptacle for receiving the foodstuff, said receptacle being in addition to the transport belt, is therefore unnecessary. Rather, the foodstuff can simply be placed onto the transport belt.

Moreover, the apparatus according to the invention can advantageously be integrated particularly simply into an existing conveyor system. It is hereby conceivable that the conveyor system is formed from a plurality of apparatuses, in particular a cutting apparatus and an apparatus for shaping and a plurality of transport belts connecting these, into which the apparatus according to the invention can be integrated particularly simply. The foodstuff must therefore be placed only once onto a first transport belt. A manual placement of the shaped foodstuff onto a transport belt, which conveys the foodstuff to a downstream cutting device, or a manual insertion into the cutting machine itself, is thereby no longer necessary. Rather, the shaped foodstuff can be conveyed by means of the same transport belt or by means of a further transport belt to the cutting device without a reorientation or removal of the foodstuff from the apparatus beforehand being necessary. Namely, in its shaped state, the foodstuff already occupies a precisely defined position on the transport belt of the apparatus, which position results in the foodstuff being able to be passed on without repositioning even upon further transport.

Moreover, it can be ensured that, after the shaping process, the foodstuff is not deformed again as a result of an ejection, as is known from the prior art. Rather, the shape of the foodstuff obtained by means of the apparatus is maintained by passing the foodstuff by means of a transport belt.

According to a further feature of the invention, it is provided that the transport belt is movable parallel to a direction in which the pressing chamber has a greatest longitudinal extent.

In this way, a transport belt can advantageously be used whose width —measured perpendicular to a movement direction of said transport belt —substantially corresponds to, preferably exceeds, a width of the foodstuff. The apparatus can hereby be integrated particularly simply into a conventional transport system, in which the existing transport belts are likewise dimensioned in such a way that a bearing of the foodstuff is provided in such a way that a longitudinal axis of the foodstuff corresponds to the movement direction of the transport belt.

It is preferably provided that a length of the apparatus hereby substantially corresponds to or exceeds a length of the foodstuff to be shaped. The foodstuff can hereby be transitioned — without a prior division into a plurality of pieces — into the desired shape by means of a single shaping process, wherein a division is absolutely likewise conceivable given particularly long foodstuffs.

In an alternative embodiment, however, it is also conceivable that the transport belt is movable perpendicular to the direction of the greatest longitudinal extent of the pressing chamber. In this instance, the width of the transport belt should correspond to a length of the pressing chamber in the initial state.

According to a preferred embodiment of the invention, the transport belt encloses a wall of the pressing chamber between a carrying run and a return run. In other words, the transport belt runs around the wall of the pressing chamber so that said pressing chamber is covered by the transport belt. It is thereby preferably provided that the wall that is covered by the transport belt is not designed as a ram but rather only as an immovable counterpart, absorbing the pressing force perpendicular to the transport belt, to an opposite ram, so that the transport belt is not deformed in a shaping process as a result of a movement of the enclosed wall. The pressing chamber can thus be combined particularly simply with a conventional transport belt.

According to an advantageous embodiment of the invention, it is provided that a width of the transport belt, measured transverse to a movement direction of the transport belt, is greater than a width of the pressing chamber, measured transverse to the movement direction of the transport belt, preferably in the final state of said pressing chamber, further preferably in the initial state of said pressing chamber.

The transport belt accordingly projects beyond edge regions of the pressing chamber. In this way, it can be ensured that the foodstuff preferably comes into contact only with the transport belt, at least in the final state of the pressing chamber, in order to enable the foodstuff to be conveyed. An adhesion of the foodstuff to a wall next to the transport belt can thereby be avoided.

Starting from a method for shaping a strand-shaped foodstuff, in particular a piece of meat, the aforementioned object is achieved in that the foodstuff is conveyed by means of a transport belt into the pressing chamber and/or out of the pressing chamber, wherein the transport belt at least partially covers a wall of the pressing chamber.

The method according to the invention hereby initially comprises four steps: In a first step, a pressing chamber delimited by the walls is opened in that at least one of the walls is moved relative to at least one other of the walls, whereby an opening cross-section is uncovered. In the initial state and in the final state, the pressing chamber surrounds the foodstuff. In order to be able to introduce the foodstuff into the pressing chamber, at least one of the walls must therefore be movable in such a way that an opening cross-section is uncovered, which substantially corresponds to a cross-section of the foodstuff, preferably is somewhat larger, so that the foodstuff can be introduced into the pressing chamber optimally without collision. In a second step, the foodstuff is introduced through the opening cross-section into the pressing chamber, preferably by means of the feed device. In a third step, the opening cross-section of the pressing chamber is closed again, and the foodstuff is transitioned from an unshaped state into a shaped state by movement of walls, designed as rams, of the pressing chamber. The pressing chamber is therefore in its final state. In a fourth step, an opening cross-section of the pressing chamber is uncovered, and the shaped foodstuff is discharged from the pressing chamber through this opening cross-section. The discharge of the foodstuff preferably takes place by means of the discharge device.

Given a row-by-row supplying of a plurality of foodstuffs, it is thereby preferably provided that, upon uncovering the opening cross-section for discharging a first foodstuff, an opening cross-section for supplying a second, downstream foodstuff is uncovered at the same time, and the procedure is analogous for the following foodstuffs. The method can advantageously be accelerated in this way.

The advantages mentioned in relation to the apparatus according to the invention are thereby achieved analogously by means of the method described above.

An advantageous embodiment of the invention provides that at least one wall of the pressing chamber, preferably two walls arranged on opposite sides of the pressing chamber, can be moved transverse to a direction in which the respective wall is movable during the conversion of the pressing chamber from the initial state into the final state, whereby an opening cross-section for the feeding of the unshaped foodstuff and/or the discharge of the shaped foodstuff is created.

It has been found that such an embodiment is particularly suitable for uncovering an opening cross-section for inserting the foodstuff into the pressing chamber. For example, it is hereby conceivable that a wall which forms an upper side of the pressing chamber, which wall is designed in the form of a ram movable in a first direction, is coupled to two walls which form sides of the pressing chamber. The walls forming the sides can be designed as rams which are movable in opposite directions.

By means of a coupling of two rams, it is thus possible to use a common pressing device for those rams that uncover the opening cross-section of the pressing chamber, so that the number of required pressing devices can be reduced.

The pressing devices are hereby designed, for example, in the form of an electromechanical cylinder, which are driven by a servomotor. It is also likewise conceivable that the pressing devices are formed by hydraulic cylinders or linear motors. In any event, it is particularly advantageous if the pressing devices can be operated in a pressure-controlled manner so that a movement of the rams is automatically ended upon achieving a prespecified final pressure.

A particularly advantageous development of the apparatus according to the invention provides that a temperature of the foodstuff is lower at least in edge regions than a temperature of the foodstuff in a core region.

It has been found that a shape of the foodstuff obtained by means of the shaping process is hereby advantageously maintained for longer, so that the foodstuff continues to be in a shaped state upon reaching a downstream cutting machine, and can nevertheless be cut with conventional cutting machines. It is hereby preferably here that the temperature of the foodstuff in the edge regions is below 0° C. In particular, a restoring force of the foodstuff, which ensures that the foodstuff returns to its unshaped state, is hereby reduced.

It is preferably furthermore provided that, during the shaping process, pressing forces are transmitted from the foodstuff via the transport belt into a wall supporting said transport belt.

It can hereby be advantageously ensured that — although the transport belt lies in the flow of force — the pressing forces are introduced into the transport belt only as compressive forces, and not as tensile or shear forces whereby the latter would be deformed or damaged. The transport belt preferably serves only to move the foodstuff, and does not itself exert any pressing forces on the foodstuff.

A further embodiment of the invention provides that the foodstuff is transferred by means of the transport belt to a further transport belt which transfers the foodstuff to an apparatus, and/or the transport belt takes over the foodstuff from a further transport belt onto which the foodstuff is placed.

In this way, the apparatus can be connected particularly simply to an existing conveying system. For example, a width of the transport belt can coincide with a width of at least one further transport belt. It is likewise conceivable that a movement direction of the transport belt coincides with a movement direction of at least one further transport belt. The apparatus can in particular be a cutting apparatus, a packaging device, or a balance.

According to a preferred embodiment of the invention, it is provided that a feed position of the foodstuff on the transport belt substantially corresponds to a discharge position of the foodstuff on the transport belt after completion of the shaping process.

This results in that the foodstuff to be shaped must hereby be placed only once onto a first transport belt. It is thereby preferred if the feed position of the foodstuff is hereby prespecified, for example centrally on a first transport belt, by means of a positioning device, preferably in the form of a guide rail.

In particular, in this way, prior to reaching a cutting machine which is arranged downstream in terms of time and space of the apparatus for shaping, the foodstuff does not need to be reoriented on a transport belt, whereby a working step can be saved. The foodstuff can therefore be placed onto a first transport belt, shaped by means of the device, and cut into slices by means of a cutting machine, and subsequently be typically removed as a packaged portion without a further positioning step being herby required.

It is thereby preferably provided that the foodstuff is conveyed by means of various transport belts, wherein the feed position of the foodstuff is maintained even upon transfer to a subsequent transport belt.

A preferred embodiment of the invention provides that, during the insertion of the foodstuff into the pressing chamber, at least one wall designed as a ram is moved perpendicular and/or parallel to a movement direction of the foodstuff in which the foodstuff is fed to the pressing chamber, preferably in the movement direction or perpendicular thereto, so that a distance between the wall and an opposite wall of the pressing chamber is reduced.

In this way, the size of the pressing chamber can already be adapted to the foodstuff before a final positioning of the foodstuff in the pressing chamber. The time expenditure for shaping a foodstuff can hereby be advantageously reduced, since travel paths of the rams in a subsequent shaping process are reduced. A light barrier is thereby preferably provided that determines a length of the foodstuff. By means of the determined length, the distance between the opposite walls can be adapted in such a way that said distance substantially corresponds to, preferably slightly exceeds, the length of the foodstuff, so that the foodstuff can be arranged between the walls and can be finally shaped.

The pressing chamber is preferably delimited, namely furthermore preferably in all three spatial directions perpendicular to one another, by (respective) walls oriented parallel to one another in pairs.

### EXEMPLARY EMBODIMENT

The invention described above is explained in more detail below using an exemplary embodiment which is illustrated in Figures.

Shown are:

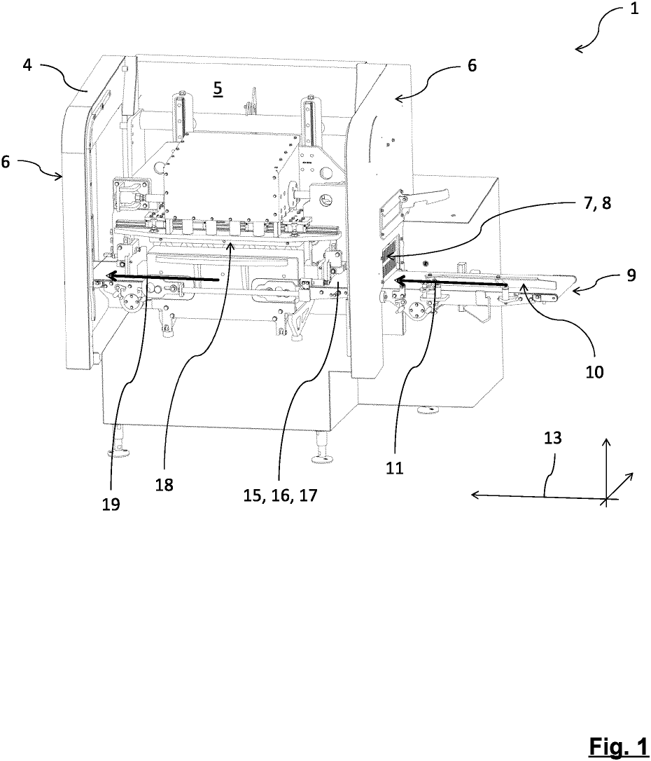

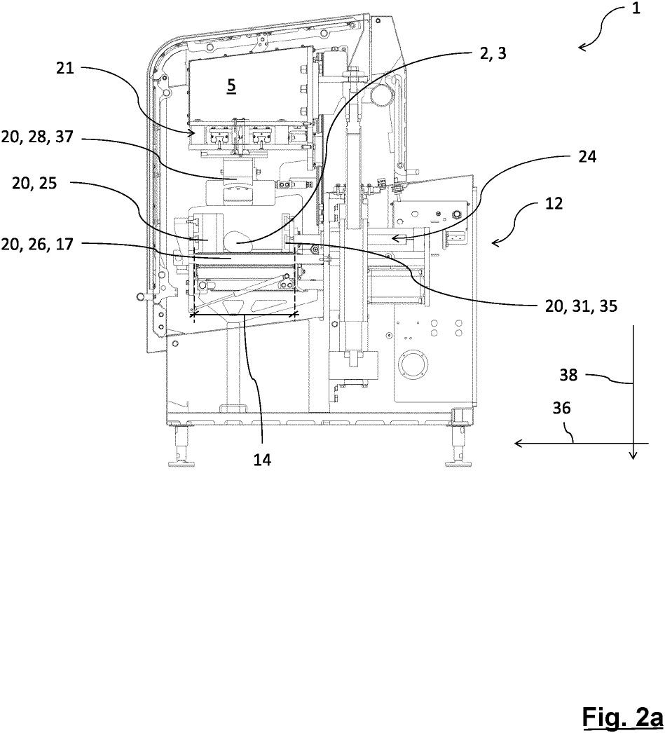

FIG. 1: a perspective view of an apparatus according to the invention,

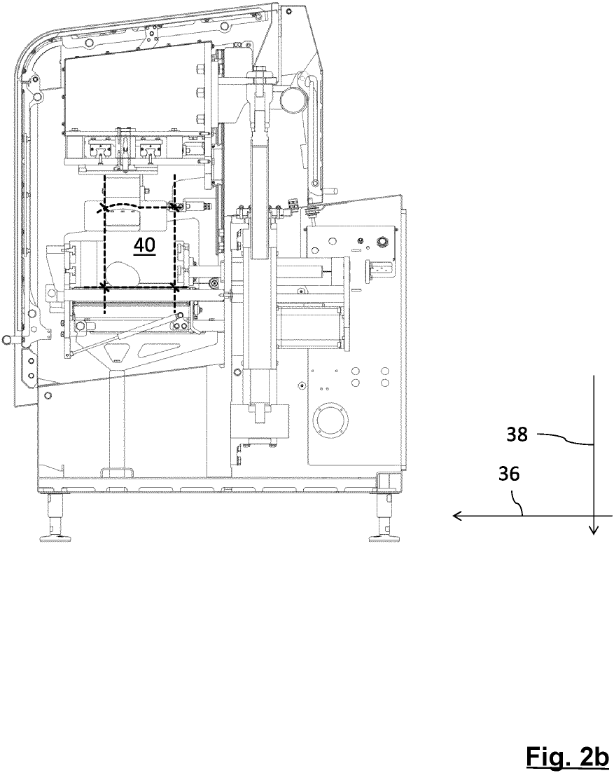

FIG. 2a: a vertical section through the apparatus of FIG. 1,

FIG. 2b: like FIG. 2a, wherein an opening cross-section of a pressing chamber is identified,

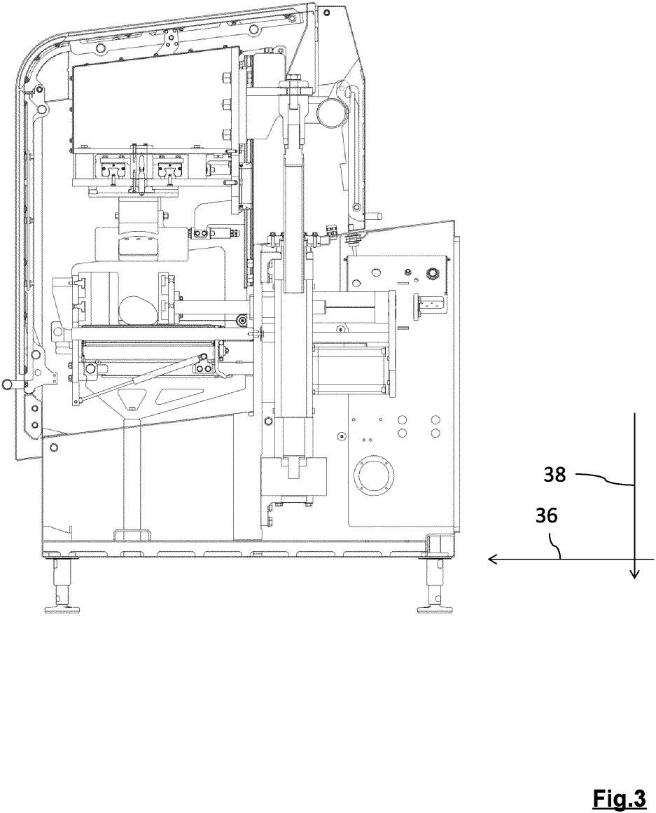

FIG. 3: like FIG. 2a, wherein a ram of the pressing chamber is displaced,

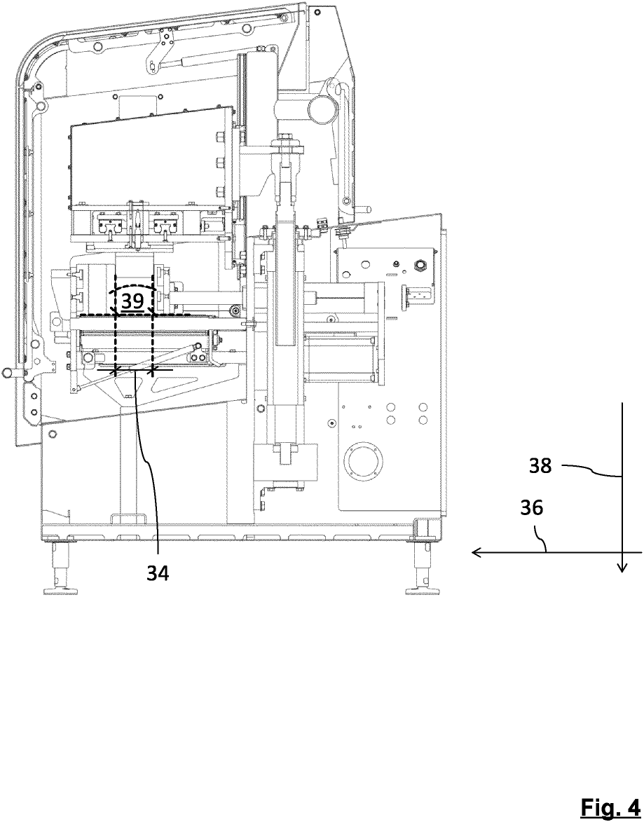

FIG. 4: like FIG. 3, wherein a further ram is displaced,

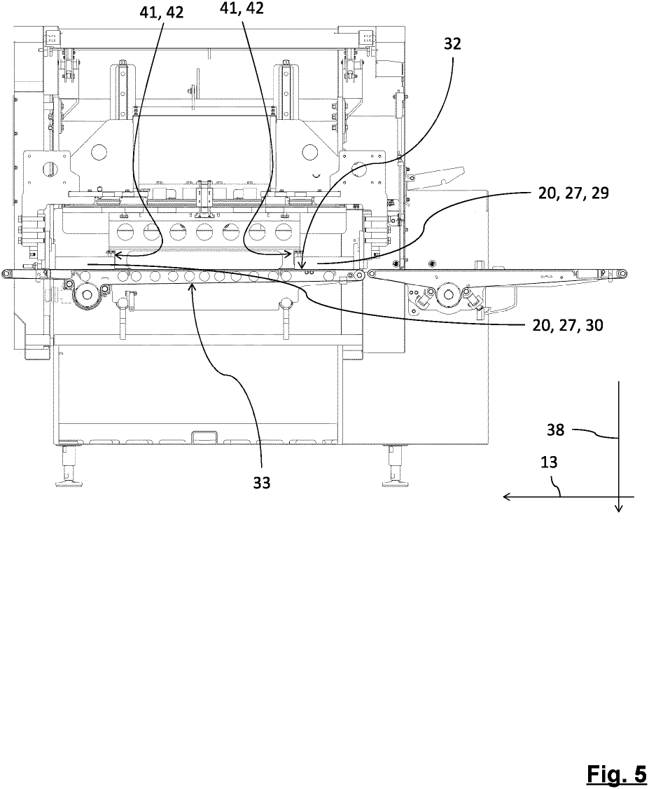

FIG. 5: a further vertical section through the apparatus of FIG. 1,

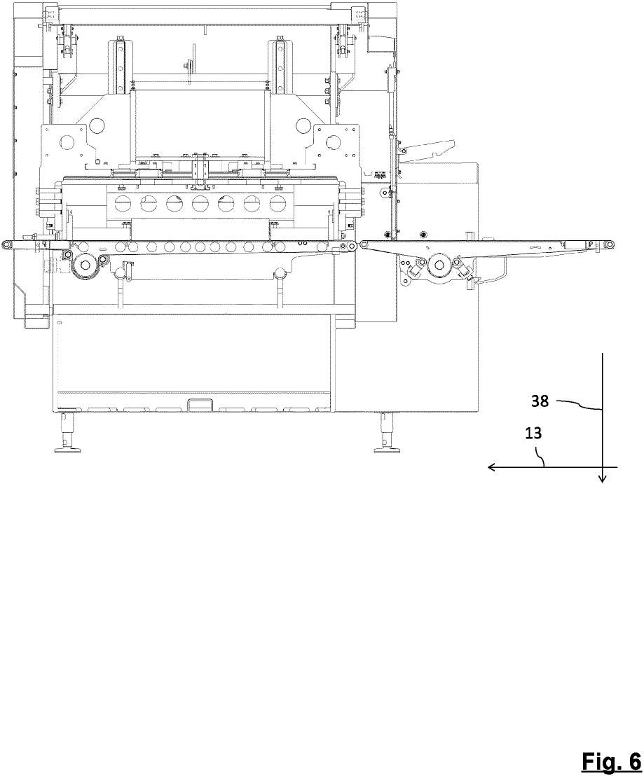

FIG. 6: like FIG. 5, wherein a further ram is displaced,

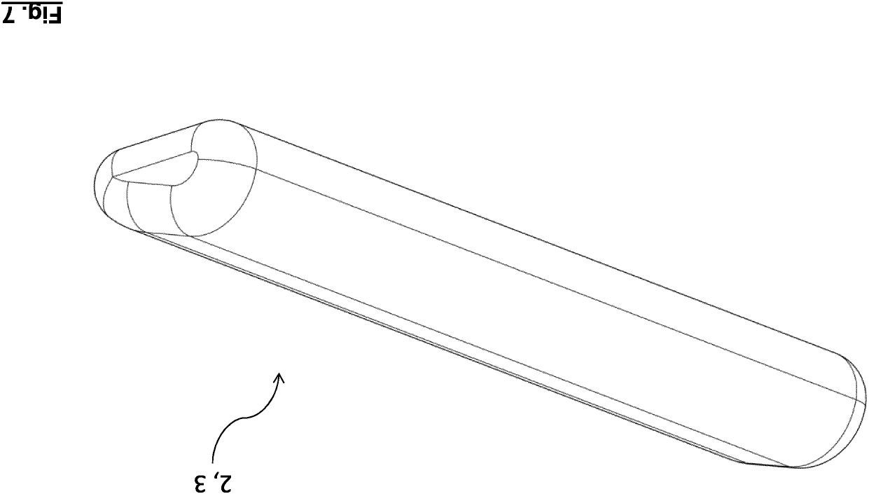

FIG. 7: a schematic representation of a foodstuff in an unshaped state, and

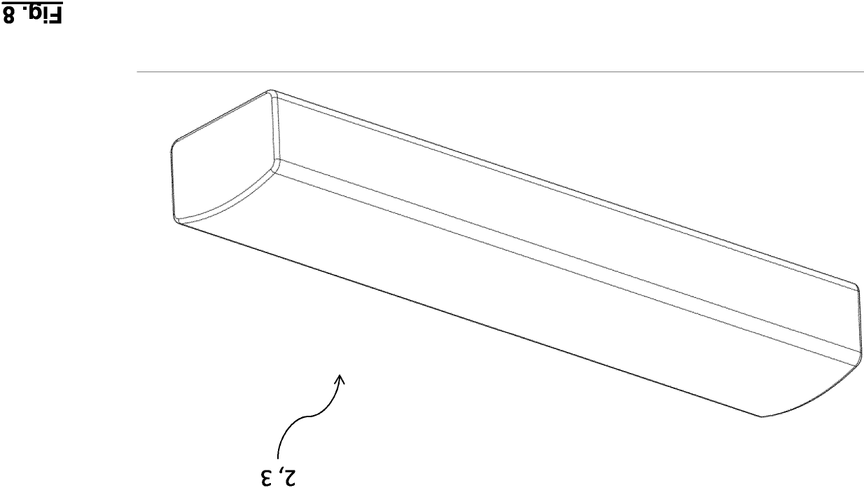

FIG. 8: like FIG. 7, wherein the foodstuff is present in a shaped state.

An exemplary embodiment that is shown in FIGS. 1 to 6 comprises an apparatus 1 according to the invention for shaping a strand-shaped foodstuff 2 in the form of a piece of meat 3, wherein the piece of meat 3 has a nonuniform surface contour which is to be corrected by means of the apparatus 1. The piece of meat 3 in an unshaped state is shown in FIG. 7.

The apparatus 1 according to the invention comprises a housing 4 which encloses an interior 5 and which is provided with a respective closable opening 7 on two opposite side walls 6. The openings 7 form a feed opening 8 and a discharge opening, wherein only the feed opening 8 is shown in Figures. A respective transport belt 9 is arranged at the openings 7, wherein only the transport belt 9 associated with the feed opening 8 is shown in Figures. The transport belt 9 is hereby provided for the initial placement of the foodstuff 2. In order to hereby ensure a positioning of the foodstuff 2 on the transport belt 9 that is suitable for a subsequent shaping and cutting process, the apparatus 1 is provided with a stationary positioning device 10 in the form of a guide rail, which transitions the placed foodstuff 2 into an initial position in which it rests centrally on the transport belt 9. A movement direction 11 of the transport belt 9 is hereby oriented parallel to a front side 12 of the apparatus 1, wherein the movement direction 11 of the transport belt 9 defines an X-direction 13. Upon placement of the foodstuff 2 onto the transport belt 9, the foodstuff 2 is conveyed in the X-direction 13 to the feed opening 8. In the event that the foodstuff 2 does not hereby already rest centrally — relative to a width 14 of the transport belt 9 — on the transport belt 9, a correction of the position takes place by means of the positioning device 10, in that the foodstuff 2 slides along the positioning direction 10 during the movement and is hereby displaced transverse to the movement direction 11 and oriented. A bearing of the positioning device 10 relative to the transport belt 9 is adjustable so that the position of the foodstuff 2 can be corrected depending on a width of said foodstuff 2.

Moreover, the apparatus 1 according to the invention has a feed device 15 as well as a discharge device 16 in the form of a single transport belt 17 running through the interior 5 of the apparatus 1, wherein, by means of the transport belt 17, the strand-shaped foodstuff 2 can be fed to a pressing chamber 18 arranged in the interior 5 of the apparatus 1 and can be discharged from the pressing chamber 18. A movement direction 19 of the transport belt 17 hereby likewise runs in the X-direction 13.

By means of the third transport belt, which is arranged at the discharge opening, the foodstuff 2 can be conveyed to a cutting device (likewise not shown in Figures) which divides the shaped foodstuff 2 into slices.

The foodstuff 2 is passed from the first transport belt 9 to the second transport belt 17, from which the foodstuff 2 is passed to the last transport belt, wherein a respective width 14 of the transport belts 9, 17 coincides. The first transport belt 9 hereby extends partially into the interior 5 of the apparatus 1, so that a passing of the foodstuff 2 takes place in the interior 5 of the apparatus 1. A feed of the foodstuff 2 into the pressing chamber 18 and a discharge of said foodstuff 2 thus take place on two opposite sides of the pressing chamber 18. The foodstuff 2 is thereby moved continuously in the X-direction 13 so that the initial position of the foodstuff 2 — relative to the width of the transport belts 9, 17 — coincides with an end position of the same after passing through the apparatus 1, so that the initial position can also already be substantially prespecified for the subsequent cutting device upon placement onto the first transport belt 9. All three transport belts run in the horizontal direction, and surfaces of the carrying runs are located at the same level in the Z-direction.

The pressing chamber 18 is arranged in the interior 5 of the apparatus 1, said pressing chamber 18 consisting of six walls 20, four of which are designed as rams 28, 29, 30, 31 and are respectively movable in different directions by means of an associated pressing device 21, 22, 23, 24.

A wall 20 forming a front side 25 of the pressing chamber 18 and a wall 20 forming a floor 26 of the pressing chamber 18 are hereby fixedly connected to the apparatus 1 and the machine frame thereof, whereas the other walls 20 form movable rams 28, 29, 30, 31 which are respectively displaceable in one direction relative to the machine frame and to the foodstuff 2. For this purpose, the rams 28, 29, 30, 31 are respectively coupled to a pressing device 21, 22, 23, 24 respectively in the form of an electromechanical cylinder which is driven by a servomotor. By means of the pressing devices 21, 22, 23, 24, a pressure-controlled movement of the associated rams 28, 29, 30, 31 takes place, wherein the movement is automatically ended upon reaching a prespecified final pressure. A thickness of the wall 20 forming the front side 25 of the pressing chamber 18 is hereby designed to be adjustable to adapt to a cutting cross-section of the apparatus 1, so that the pressing chamber 18 can be adapted to a width of the foodstuff 2 to be shaped.

The wall 20 forming the floor 26 of the pressing chamber 18 is hereby fixedly mounted in the machine frame and covered with the second transport belt 17, wherein the floor 26 is enclosed between a carrying run 32 and a return run 33 of the second transport belt 17. A width 14 of the second transport belt 17 is hereby larger than a width 34, measured transverse to the movement device 11 of the transport belt 17, of the pressing chamber 18 in a final state, which is described in detail in conjunction with FIGS. 2 to 6. The floor 26 of the pressing chamber 18 is consequently completely covered by the transport belt 17, so that pressing forces introduced in the Z-direction into the foodstuff 2 during the shaping process are transmitted from the foodstuff 2 via the transport belt 17 into the floor 26.

The fourth ram 31 forming a rear side 35 of the pressing chamber 18 is movable in a Y-direction 36 running perpendicular to the X-direction 13, wherein the first ram 28 forming an upper side 37 of the pressing chamber 18 is movable in a Z-direction 38 which is oriented perpendicular to the X-direction 13 and to the Y-direction 36. The upper side 37 of the pressing chamber 18 is thereby designed in the shape of a circular arc as viewed in a vertical cross-section. The second and third rams 29, 30 forming the two remaining sides 27 of the pressing chamber 18 are movable in the X-direction 13 or counter to the X-direction 13, wherein the same with their pressing devices 22, 23 are coupled to the first ram 28 and its associated pressing device 21 in such a way that they also move in the Z-direction 36 given a movement of the upper side 37. Furthermore, the respective ram 29, 30 has a contact element 42 which is arranged on an end facing toward the foodstuff 2. In the final state of the pressing chamber 18, the contact element 42 forms a contact surface which is in contact with the foodstuff 2. The respective contact surface 41 of the second and third rams 29, 30 is hereby designed to be variable in size. The contact element 42 is thereby designed as a folded metal sheet, which is fastened movably by means of a spring on the respective ram 29, 30 on the one hand and firmly on the first ram 28 on the other hand, so that a relative movement between the respective ram 29, 30 and the first ram 28 is enabled. The ram 28 is, with its pressing device 21, hereby respectively coupled by means of a linear guide to the second and third rams 29, 30 and the associated pressing device 22, 23. In the initial state of the pressing chamber 18, the spring is deflected by the respective ram 29, 30 due to gravity in such a way that a segment of the contact element 42 projects beyond a surface of the respective ram 29, 30. In an initial state of the pressing chamber 18 which is shown in FIG. 2a, said pressing chamber 18 has a first enclosed volume, wherein the initial state is present when the rams 28, 29, 30, 31 are retracted in such a way that feeding the foodstuff 2 into the pressing chamber 18 is enabled. The volume enclosed by the pressing chamber 18 is hereby enclosed by planes which correspond to an imaginary extension of the walls 20 of the pressing chamber 18.

As a result of a translational displacement of the four rams 28, 29, 30, 31, the pressing chamber 18 can be transitioned from its initial state into a final state in which it has a second enclosed volume. The walls 20 of the pressing chamber 18, which walls are designed as rams 28, 29, 30, 31 and overall form a “half chamber”, are moved relative to the foodstuff 2. The final state of the pressing chamber is shown in FIGS. 4 and 6.

In order to shape the foodstuff 2, the pressing chamber 18 is first transitioned into its initial state in that the pressing chamber 18 is opened. For this purpose, the first ram 28 of the pressing chamber 18 is moved with the second and third rams 29, 30 counter to the Y-direction 36, so that an opening cross-section 40 is uncovered, which can be clearly seen in FIG. 2b. The opening cross-section 40 of the pressing chamber 18 hereby exceeds a cross-section of the foodstuff 2 so that the latter can be fed to the pressing chamber 18.

The foodstuff 2, which has been tempered for better shaping capability in such a way that a temperature, at least in edge regions of the foodstuff 2, is reduced in comparison to a temperature of the foodstuff 2 in a core region, is subsequently introduced by means of the first transport belt 9 into the pressing chamber 18. The foodstuff 2 has thereby been placed by means of the positioning device 10 onto the first transport belt 9 in such a way that, upon being introduced into the pressing chamber 18, it rests close to the wall 20 forming the rear side 35, as shown in FIG. 2a. In the course of the introduction of the foodstuff 2 into the interior 5 of the apparatus 1, a length measurement of the foodstuff 2 takes place by means of a light barrier (not shown in Figures).

As soon as the foodstuff 2 is arranged centrally in the apparatus 1, the feed opening 8 is closed again by means of a closure element, and the foodstuff is transferred to the second transport belt and is oriented centrally with respect to the transport belt, relative to the pressing chamber. The second and third rams 29, 30 are hereby already moved in the X-direction 13 and counter to the X-direction 13 so that a distance between the two rams 29, 30 is reduced in such a way that said distance substantially corresponds to, preferably slightly exceeds, a length of the foodstuff 2. The second conveyor belt 17 is stopped. Subsequently — as is readily apparent in FIG. 3 — the ram 31 forming the rear side 35 of the pressing chamber 18 is moved in such a way that it comes into contact with the foodstuff 2. As a result of pressing forces which are exerted on the foodstuff 2 by the ram 31 forming the rear side, the foodstuff 2 escapes in the X-direction 36 and in the Z-direction 38. Analogously, the first ram 28 is brought into contact with the foodstuff 2 by means of a movement of the former in the Z-direction 38, as is readily apparent in FIG. 4. In the course of the movement of the first ram 28 in the Z-direction 38, the ram 28 comes into contact with the foodstuff 2. The contact element 42 is are hereby initially still deflected. Given a further exertion of pressure, the second and third rams 29, 30 come into contact with the transport belt 17. The linear guide, in conjunction with the spring, then enables the first ram 28 to be further displaced in the Z-direction 38 in that the contact element 42 is displaced in the Z-direction 38, so that the contact surface 41 of the respective ram 29, 30 is hereby reduced in size. The foodstuff 2 is consequently compressed in the Z-direction 38, whereby an increased extension of the foodstuff 2 in the X-direction 13 and counter to the X-direction 13 is brought about, while a cross-section of the foodstuff 2 parallel to a Y/Z-plane already corresponds to a “final cross-section” of the pressing chamber 18. Likewise, the rams 29, 30 forming the sides 27 of the pressing chamber 18 are moved in the X-direction 13 or counter to the X-direction 13 in order to come into contact with the foodstuff 2, as can be seen in FIGS. 5 and 6. The pressing chamber 18 is consequently in its final state, in which all walls 20 of the pressing chamber 18 are in contact with the foodstuff 2 and pressing forces are introduced by the rams 28, 29, 30, 31 into the foodstuff 2. The foodstuff 2, which is enclosed in an interior 39 of the pressing chamber 18, is hereby transitioned into a shaped state, which can be seen in FIG. 8 and should be approximated optimally well to a cuboid.

Subsequently, the walls 20 designed as rams 28, 29, 30, 31 are removed in reverse order from the foodstuff 2, wherein the latter remains substantially in its shaped state.

Lastly, the foodstuff 2 is conveyed by means of the second transport belt 17 in the X-direction 13, out of the pressing chamber 18 and the interior 5 of the apparatus 1. The first ram 28 of the pressing chamber 18 is thereby moved again with the second and third rams 29, 30 counter to the Y-direction 36, so that a second opening cross-section opposite the first opening cross-section 40 is uncovered, which second cross-section exceeds a cross-section of the foodstuff 2 so that the latter can be discharged from the pressing chamber 18. Finally, the foodstuff 2 is transferred to the third transport belt, by means of which the foodstuff 2 can be transported to the cutting machine.

### LIST OF REFERENCE SIGNS

1 Apparatus
2 Foodstuff
3 Piece of meat
4 Housing
5 Interior
6 Side wall
7 Opening
8 Feed opening
9 First transport belt
10 Positioning device
11 Movement direction
12 Front side
13 X-direction
14 Width
15 Feed device
16 Discharge device
17 Transport belt
18 Pressing chamber
19 Movement direction
20 Wall
21 First pressing device
22 Second pressing device
23 Third pressing device
24 Fourth pressing device
25 Front side
26 Floor
27 Side
28 First ram
29 Second ram
30 Third ram
31 Fourth ram
32 Carrying run
33 Return run
34 Width
35 Rear side
36 Y-direction
37 Upper side
38 Z-direction
39 Interior
40 Opening cross-section
41 Contact surface
42 Contact element

1. An apparatus for shaping a strand-shaped foodstuff comprising a piece of meat, comprising:
a pressing chamber which is delimited by walls, at least one of which is movable by a pressing device and is designed as a ram, whereby the pressing chamber is transitioned from an initial state with a first enclosed volume into a final state with a second enclosed volume;
a feed device for feeding the foodstuff into the pressing chamber; and
a discharge device for discharging the foodstuff from the pressing chamber,
wherein the feed device and/or the discharge device is a transport belt which at least partially covers one of the walls in an interior of the pressing chamber.

2. The apparatus according to claim 1, wherein the transport belt is movable parallel to a direction in which the pressing chamber has a greatest longitudinal extent.

3. The apparatus according to claim 1, wherein the transport belt encloses a wall of the pressing chamber between a carrying run and a return run.

4. An apparatus according to claim 1, wherein a width of the transport belt measured transverse to a movement direction of the transport belt is greater than a width of the pressing chamber measured transverse to the movement direction of the transport belt, in the final state of said pressing chamber, or in the initial state of said pressing chamber.

5. A method for shaping a strand-shaped foodstuff comprising a piece of meat, comprising:
opening a pressing chamber delimited by walls by way of at least one of the walls is moved relative to at least one other of the walls , whereby an opening cross-section is uncovered,
introducing the foodstuff through the opening cross-section into the pressing chamber,
closing the opening cross-section of the pressing chamber again, and transitioning the foodstuff from an unshaped state into a shaped state by moving walls, configured as rams, of the pressing chamber,
uncovering an opening cross-section of the pressing chamber, and discharging the shaped foodstuff is discharged from the pressing chamber through this opening cross-section; and
conveying the foodstuff by a transport belt into the pressing chamber and/or out of the pressing chamber, wherein the transport belt at least partially covers a wall of the pressing chamber.

6. The method according to claim 5, wherein at least one wall of the pressing chamber is arranged on opposite sides of the pressing chamber is moved transverse to a direction in which the respective wall is movable during the transition of the pressing chamber from the initial state into the final state, whereby an opening cross-section for feeding the unshaped foodstuff and/or discharging the shaped foodstuff is created.

7. The method according to claim 5, wherein a temperature of the foodstuff is lower at least in edge regions than a temperature of the foodstuff in a core region.

8. The method according to claim 5, wherein during the shaping process, pressing forces are transmitted from the foodstuff via the transport belt into a wall supporting said transport belt.

9. The method according to claim 5, wherein the foodstuff is transferred by the transport belt to a further transport belt which transfers the foodstuff to an apparatus, and/or the transport belt takes over the foodstuff from a further transport belt onto which the foodstuff is placed.

10. The method according to claim 5, wherein a feed position of the foodstuff on the transport belt substantially corresponds to a discharge position of the foodstuff on the transport belt after completion of the shaping process.

11. The method according to claim 5, wherein , during the introduction of the foodstuff into the pressing chamber , at least one wall configured as a ram is moved perpendicular and/or parallel to a movement direction of the foodstuff in which the foodstuff is fed to the pressing chamber in the movement direction or perpendicular thereto, so that a distance between the wall and an opposite wall of the pressing chamber is reduced.

12. The method according to claim 5, wherein the transport belt is stationary during the transition of the foodstuff from the unshaped into the shaped state.
